(19) United States
(12) Patent Application Publication
(10) Pub. No.: US 2005/0278340 A1
(43) Pub. Date: Dec. 15, 2005

(54) Problem solving assistant

(76) Inventors: Charles Patrick Rehberg, Nashua, NH (US); Kuppili Rajesh Babu, Karnataka (IN)

Correspondence Address: FISH & RICHARDSON PC, P.O. BOX 1022, MINNEAPOLIS, MN, 55440-1022, US

(21) Appl. No.: 10/856,273

(22) Filed: May 28, 2004

(51) Int. Cl. G06F 17/30

(52) U.S. Cl. 707/10

(57) ABSTRACT

A computer-assisted problem resolution system is configured using documents that relate to problem resolution in a domain. An automated information extractor is configured to identify problem resolution information from the documents. The information extractor identifies portions of documents, each portion being associated with a phase of problem resolution, such as a problem, cause, or solution phase. The information extractor is also configured to determine relevance conditions associated with the identified portions of the documents. The information extractor may be configured to identify information associated with each of multiple sequential phases of problem resolution. The system then guides a user through the phases to resolve a problem.

### BACKGROUND

This invention relates to computer-aided problem solving.

In many domains, people are put in the position of having to diagnose and solve problems that arise based on characteristic features of the problem. One such domain relates to computer hardware and software; there are a great number of other domains as well. In one mode of addressing a problem, the person (e.g., an end user) seeking to address the problem contacts an intermediary who has access to information or expertise related to the problem. For example, an end user may contact a support agent by telephone. The support agent elicits relevant information from the end user, and (hopefully) in return provides a solution.

In some domains, it may be sufficient for the support agent to be skilled in the domain so that he can solve the end user's problem based on his own expertise, possibly augmented by various forms of reference documents such as technical manuals. In order to help support agents (or even the end users directly) some organizations assemble documentation of known or typical problems and their respective solutions. The agent may then be able to search through such assembled documentation when trying to solve an end user's problem.

As domains have become more complex, various computer-based support tools have been developed to aid support agents and end users. One such support tool is a keyword based search engine for locating relevant electronically stored documentation and problem/solution information. Some more automated support tools aim to guide a support agent through a series of questions to narrow down the likely problem the end user is facing. The technologies underlying automated tools include decision trees, case-based reasoning, and Bayesian networks. For example, in some decision-tree approaches, a sequence of questions is predetermined such that the next question asked depends on the answers to the previous questions.

In some domains, information about problems changes relatively quickly, for example, due to new problems arising, being discovered or being solved. For example, when a new system is deployed to end users previously unknown problems may arise for which solutions are not yet documented. Some automated systems are difficult to update in the face of changing information, and without timely updating, their utility is greatly diminished. For example, a decision-tree of questions may have to be rebuilt to accommodate the new problem and solution.

### SUMMARY

In one aspect, in general, the invention features a method and an associated system and software for computer-assisted problem resolution. Each of one or more sources of documents relate to problem resolution. An automated information extractor is configured to identify problem resolution information from documents from a corresponding source of documents. The information extractor is configured to identify portions of documents, each portion being associated with a phase of problem resolution. The information extractor is also configured to determine relevance conditions associated with the identified portions of the documents.

Aspects of the invention can include one or more of the following features.

A separate information extractor is configured for each of multiple of the sources of documents.

The sources of documents all relate to problem resolution in a single domain.

The relevance condition that is determined by the information extractor includes a logical expression based on a set of facts represented in the identified portion of a document.

The automated information extractor includes a rule-based system, and configuring the rule-based system includes determining rules for the rule-based system that representing knowledge obtained from people knowledgably in the domains which are associated with the documents.

The information extractor is applied to documents from one of the sources, and data representing at least the determined relevance conditions and the identified portions is stored in the system. The stored data can include an inference graph for problem resolution.

The information extractor is configured to identify information associated with each of multiple sequential phases of problem resolution in which each phase includes a multiple occurrences of the phase. Each identified portion of a document is associated with one of the occurrences of a phase.

The sequential phases include a problem phase followed by a solution phase, and can further include a cause phase following the problem phase and prior to the solution phase.

The information extractor is applied to documents from one of the sources and data representing the problem resolution information is stored. At least some of the problem resolution information is related to each of the sequential phases.

For each of the phases in succession, information is identified that if known would be useful for reducing a number of possible occurrences for that phase. At least some of the identified information is obtained, and possible occurrences for the phase are determined based at least on the obtained information. Determining the possible occurrences for the phase can also be based on possible occurrences determined in prior of the phases.

Each occurrence of a phase is associated with one or more indicator conditions that form a logical expression, and identifying the information useful for determining possible occurrences includes identifying indicator conditions whose value if known would contribute to determining the possible occurrences. Identifying the information can also include ordering the indicator conditions that would contribute to determining the possible occurrences. The system can prompt for the information according to the ordering, for example, by displaying indications associated with multiple of the identified information according to the ordering.

The system presents multiple completion indicators each associated with a different one of the phases. The competition indicator of each phase presents a measure of remaining possible occurrences for that phase. The measure of remaining possible occurrences can include an indicator that the number of remaining possible occurrences is below a threshold. The completion indicator for a phase can provide an indication that a next phase should be initiated.

The data related to each of the sequential phases includes a graph representation including nodes each associated with a different occurrence of the phase, and arcs coupled to the nodes, each arc being associated with an indicator condition for a node to which it is coupled. The data for multiple of the phases can include a common graph for the phases, and at least some of the arcs couple occurrences in one phase to occurrences in a following phase. The common graph can form an inference network.

Aspects of the invention can have one or more of the following advantages.

By using an automated (or semi-automated) approach to incorporating information found in the documents that relate to problem resolution, new documents can be quickly added, and large collections of documents can be processed efficiently.

By having information extractors tailored to particular sources of documents, each extractor may be simpler than if a single extractor were used for all sources of documents.

Representing problem resolution in terms of multiple phases may improve the system's ability to narrow down possibilities, for example, by identifying the most relevant questions that need to be answered.

Other features and advantages of the invention are apparent from the following description, and from the claims.

### DESCRIPTION OF DRAWINGS

FIG. 1 is a block diagram of a problem solving assistant system.

FIG. 2 is a schematic representation of a display screen.

FIG. 3 is a diagram of an inference network.

FIG. 4 is a flowchart of a problem resolution procedure.

FIG. 5 is a diagram that illustrates an information extraction process.

FIG. 6 is a data flow diagram for the information extraction processing.

### DESCRIPTION

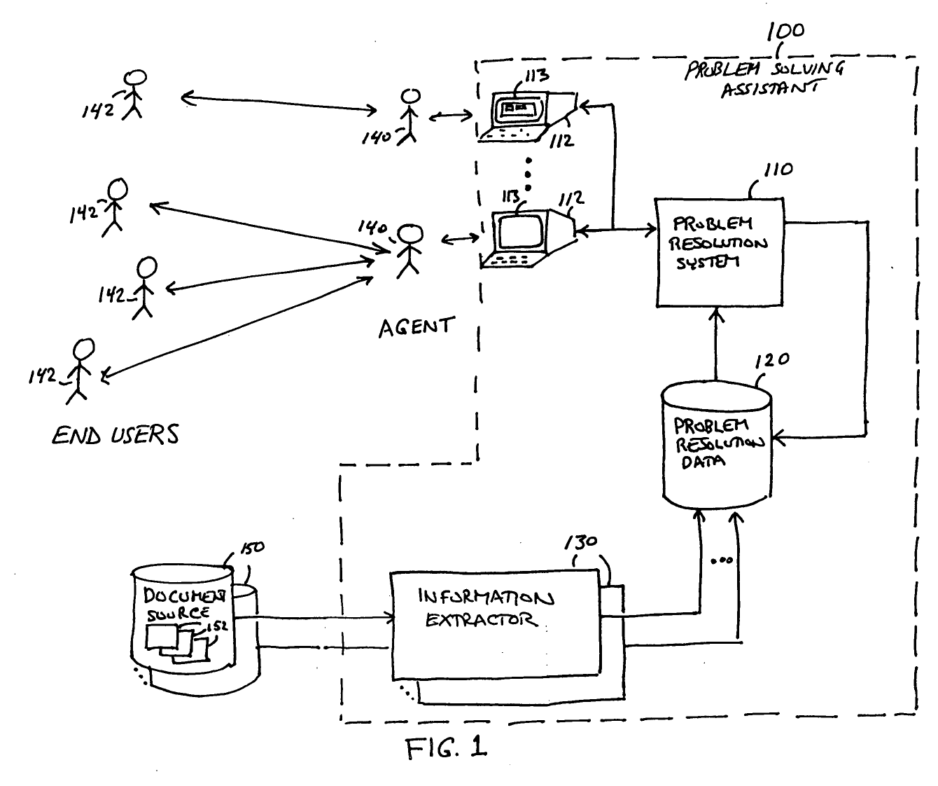

Referring to FIG. 1, a computer-aided problem solving assistant system 100 provides information to a user that aids in the resolution of a problem. For example, the system may be configured to aid in the resolution of problems in domains related to computer hardware and/or computer software, although the system is not specifically designed for such domains. In one application of the system, the users who interact directly with the system are support agents 140 who then interact with end users 142. For example, the support agents may staff a telephone call center that receives telephone calls from end users who are facing problems with a particular computer product. The call center may provide support for a large number of products, and therefore the agents are not necessarily expert in all the products.

Each agent interacts with the system using a workstation 112, which hosts a graphical user interface 113. The workstations directly host or communicate with a problem resolution system 110. While interacting with an end user 142, an agent 140 solicits information about the end user's problem and provides relevant facts to the problem resolution system. The problem resolution system makes use of the provided relevant facts and of problem resolution data 120 to narrow down on a particular problem and related solution. The resolution system also provides indications to the agent regarding which fact or facts would be most useful in resolving the problem, and the agent has the option of asking questions of the end user to solicit those facts.

The problem resolution data 120 is compiled from documents 152 that come from of one or more document sources 150. For example, one document source might be a database of articles provided by a particular vendor of software, while another document source may come from another vendor, or may have a different structure than documents from the first source. A number of information extractors 130 are tailored for particular document sources. The information extractor 130 processes each document in the source, for example, using text parsing and pattern matching techniques, and extracts relevant facts and descriptive passages for representation in the problem resolution data 120. In addition, the problem resolution data can be augmented based on successful resolutions of problems that were not previously represented in the problem resolution data using information gathered by an agent.

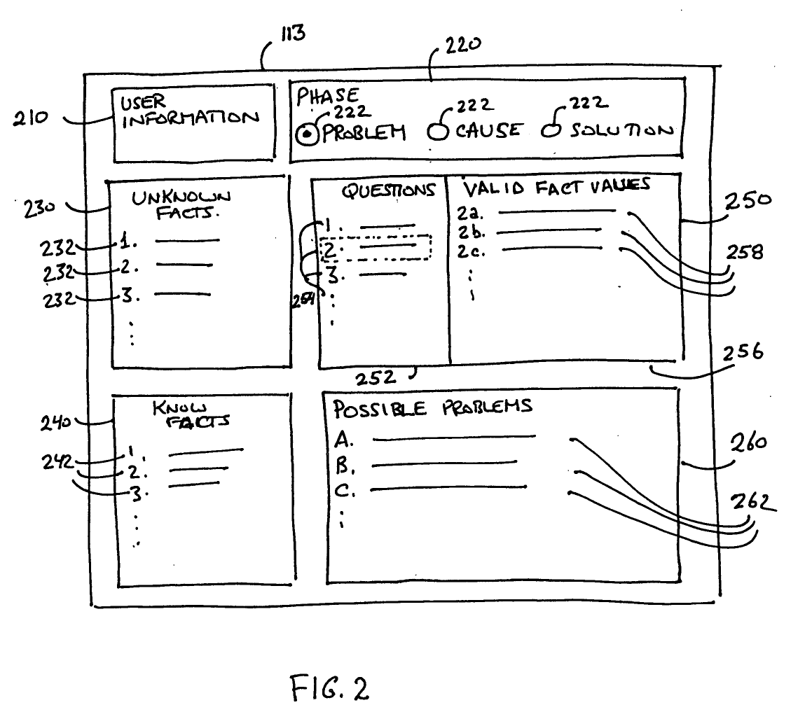

Referring to FIG. 2, the graphical user interface 113 for the agent 140 (see FIG. 1) includes a multi-part display of information related to the problem being addressed, for example, using a tiled arrangement of sub-windows. A user information section 210 presents information about the end user 142 with whom the agent is interacting. As is discussed further below, some information that is relevant to the resolution of the end user's problem may be implicit given the identity of the user, for example, based on stored information about that user's hardware or software configuration.

The problem resolution system guides the interaction with the user in a series of sequential phases. A first phase is associated with identifying the particular problem that the end user is having, a second optional phase is associated with determining a cause (if possible) of the problem, and a third phase is associated with determining a suitable solution to the cause of the problem. An indicator section 220 provides indicators 222 that identify the phase of the problem resolution that is currently being addressed by the system. At any point during a problem resolution session, the system may not yet be able to distinguish between possible problems or between possible causes of those problems or between possible solutions of the problems. As a general problem solving approach, the system guides the agent to first narrow down the problems to a small number, of problems (hopefully only one), and then to proceed with the next cause determination phase, and when the cause has been narrowed down to proceed with the solution determination phase. The indicators 222 not only show which phase is being addressed, but also indicate a degree to which that phase has been completed, for example, based on the number of remaining occurrences (e.g., specific problems, causes, or solutions) that remain possible in that phase. The indicators also provide inputs (buttons) using which the agent can select a phase to address, for example, skipping to a cause resolution phase even if the problem phase has not narrowed down to a single possible problem.

At any point during a problem resolution session, a number of facts that may be relevant to the resolution of the problem are already known, while other facts remain unknown. The graphical interface 113 includes a section for unknown facts 230 as well as section for known facts 240. For example, a fact may be the identity of the operating system being used by the user. The unknown facts section 230 includes an ordered list of identifiers of facts 232. The unknown facts are generally ordered according to how useful it would be to know the specific values associated with those facts. For example, if knowing which operating system is critical to determining how to solve the user's problem then this fact would be high on the list, while if this fact is irrelevant to resolve which of the possible problems the user is facing then this fact would be low on the list, or may be omitted entirely from the list. The specific approach to ordering these unknown facts is discussed further below.

The known facts section 240 identifies which facts have already been determined by the agent. For example, this section may initially include facts that are implicitly determined based on the identity of the user, and over the course of the problem resolution session includes additional facts entered by the agent. The list of known facts is optionally sorted according to the importance of the facts in resolving the problem. There are situations in which an agent may change the value of a “known” fact if that fact is incorrect. For example, an implicitly determined fact may be out of date. To the extent that this fact is important it may appear higher on the list suggesting that the agent may want to verify the accuracy of the fact if the system is unable to resolve the problem.

The graphical interface 113 includes a question-answer section 250 that relates to questions and valid answers (i.e., values of facts) associated with those questions. A question section 252 presents one or more questions 254 that relate to the phase being addressed. That is, if the session is in the problem determination phase, the questions relate to facts that would be useful to resolve the specific problem the user is facing. The questions are ordered according to the utility of the associated facts that would be determined from the answer to the question. This ordering is dynamically recalculated as more facts become known. The agent is not constrained to ask the questions in the order presented. For example, the user may ask a question that is later in the list for a variety of reasons. The reasons may include the flow of interaction with the end user such that asking the first question could change the topic of the conversation. For each question 254, a set of valid fact values 258 can be displayed in an answer section 256 by selecting (e.g., highlighting) that question in the question section. When the agent interacts with the end user, the agent can highlight a question in the question section 252 to see the possible answers in order to solicit a valid response from the end user. When the end user provides a response, the agent selects the corresponding answer in the answer section 256. This selection moves a fact from the unknown facts section to the know facts section. Based on the additional information provided by that fact, the system reassesses the utility of the various question and in general reorders the presentation of questions in the question section.

The graphical interface 113 also includes a resolution section 260, which show the possible solutions 262 that are consistent with the facts that are known at the particular point in the session. If there is only one solution remaining, then the agent may present the solution to the end user. If for some reason the solution is not appropriate, then it is possible that a “known” fact is actually incorrect. Alternatively, it is possible that the data does not represent the particular problem that the end user is facing.

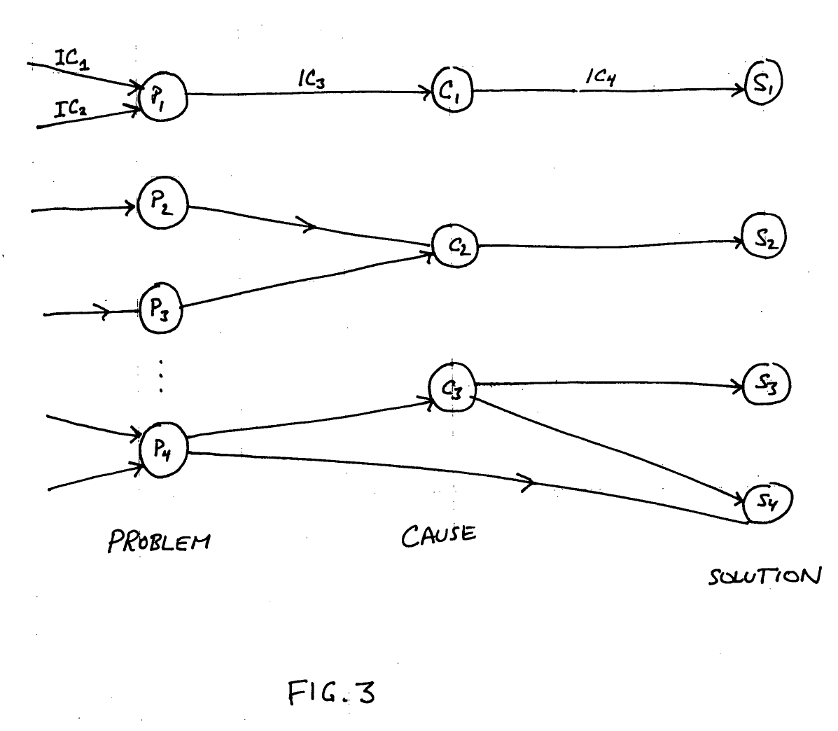

Referring to FIG. 3, the problem resolution data 120 (see FIG. 1) includes an inference graph 300, only a portion of which is illustrated in FIG. 3. The graph has nodes 310-314 each associated with a particular occurrence of a problem, cause, or solution. In FIG. 3, the problem nodes 310 are arranged in a vertical column on the left, the cause nodes 312 are arranged in a column in the center, and the solution nodes 314 are in a column on the right. The nodes are linked with arcs. Each arc has a relevance condition associated with it. The relevance condition includes a Boolean expression that depends on a set of one or more facts, which are represented using indicator conditions. Each indicator condition specifies a type of fact and a specific value (or values) of that type of fact. For example, an indicator condition may be associated with the type of fact “operating system” and the specific value “Windows 98.” The general approach to identifying a solution for a user's problem is to find a path to a solution node 314 through arcs for which the relevance conditions are known to be true. Similarly, the approach to identifying a problem or a cause is to find a path to a problem node or a cause node over arcs with relevance conditions that are true. In general, when some facts are still unknown, certain of the indicator conditions cannot be determined to be true or false. Therefore, when facts remain unknown, certain nodes have not been ruled out but do not necessarily represent the correct resolution of the problem, cause or solution.

The problem resolution system determines which facts would be most useful according to whether knowing the fact will reduce to number of nodes that cannot be ruled out. For example, in the problem phase, the system determines which fact would likely rule out the greatest number of problem nodes. Possible questions are ordered according to the utility of the associated facts in narrowing down the set of possible nodes.

When moving on to a subsequent phase, for example, moving on to a cause phase after completing processing on the problem phase, problem nodes that potentially represent the user's problem (i.e., problem nodes that have not been ruled out) are used to determine the possible cause nodes. For example, a possible problem node that is linked to a cause node by an arc with an indicator condition that is true or potentially true implies that that cause node is also true or potentially true.

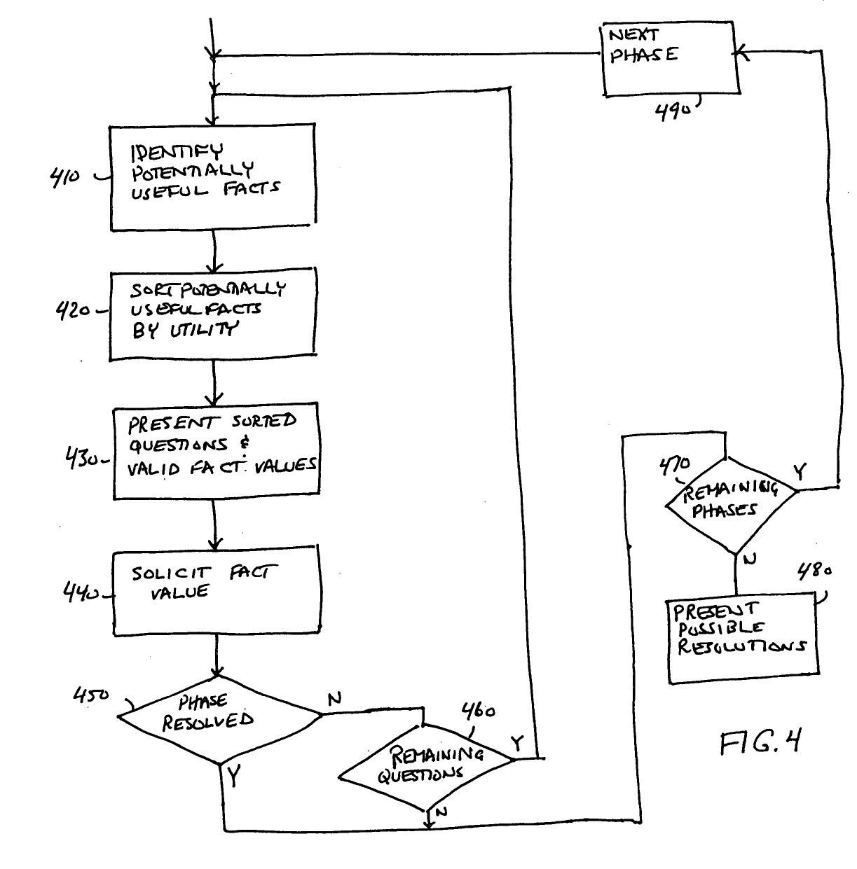

Referring to FIG. 4, the overall process of handling a user's problem begins with the problem identification phase. Note that as introduced above, the end user's identity is used to initialize the set of known facts, and therefore the initial processing may differ from user to user. First, the system identifies potentially useful facts (step 410) and orders these potentially useful facts according to their utility in narrowing down the set of possible problem nodes (step 420). Then questions associated with the potentially useful facts are presented to the agent (step 430). The agent solicits a value for a fact associated with one of the questions (step 440) and indicates the fact provided by the user to the system. Based on the new set of facts, the system determines whether the phase is resolved (step 450) by there being only a single possible problem remaining. Note that it is possible for there to be no problem remaining for a given set of facts. If this occurs, the agent can review the facts with the end user to determine if they are indeed all correct. If they are correct, then the system does not have a solution for the user's problem. Also, when a fact is provided to the system while addressing one phase, that fact may be relevant to other phases as well. For example, a newly acquired fact can narrow down the possible solution occurrences of the solution phase. If in addressing, for example, a cause phase the system can narrow down the solutions to a particular one, the indicator for the solution phase would indicate completion of that phase and the agent can jump directly to the solution rather than continuing interaction to determine the cause.

If the phase has not been resolved, then if there are remaining questions that have not yet been asked (step 460), then the system performs another iteration in the same phase (e.g., in the problem phase). If on the other hand the questions for the phase have been exhausted, and there are remaining phases (step 470) (i.e., this is not the solution phase), then the next phase is initiated (step 490) and the iteration is begun for that phase. When the last phase is resolved or there are no remaining questions, then the remaining solutions, which are associated with the possible solution nodes, are presented to the agent (step 480).

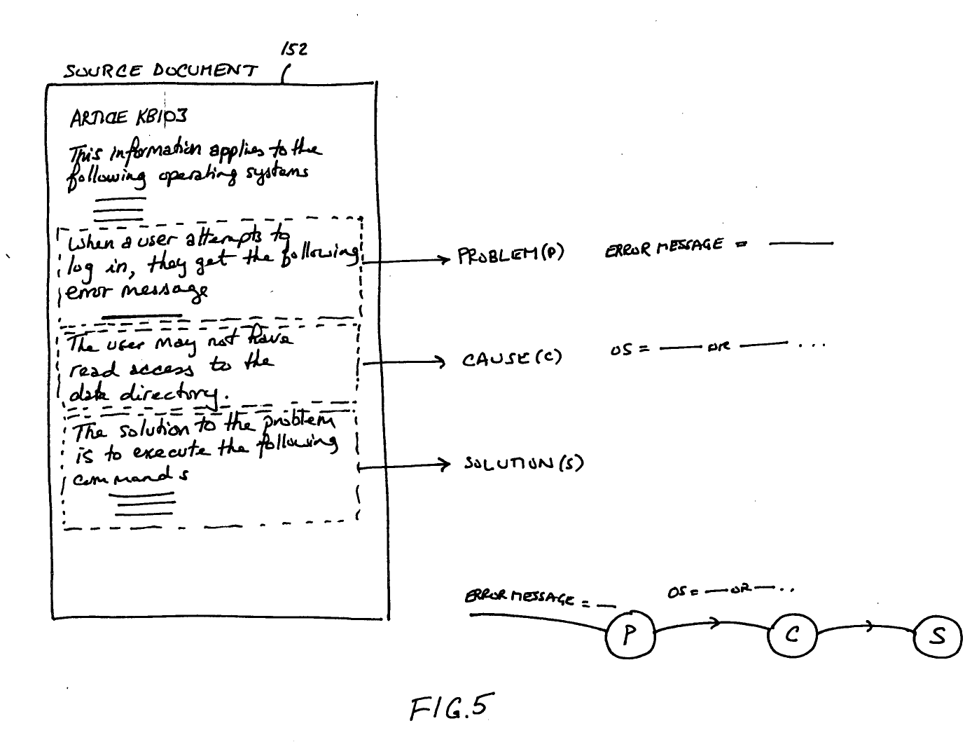

Referring to FIG. 5, the process for extracting information from source documents 152 to populate the problem resolution data 120 involves text processing. An example document is illustrated in FIG. 5. The information extractor 130 for that type of document identifies portions of the document associated with various phases of the problem resolution process. The information extractor may be specifically tailored for the format of the source document. For example, documents from that source may all include a heading “SYMPTOM” after which problem characteristics may be found. In such a case, the information extractor may be configured to locate the SYMPTOM heading and then to parse the portions of the document following the heading. The information extractor can make use of a combination of text parsing, pattern matching, rule-based techniques and special-purpose heuristics.

As an example, if the document includes a section “This information applies to the following operating systems: . . . ” then the values of the operating system would be used to construct an indicator condition that is true if the end user's operating system matches any of the values. As illustrated, different portions can be identified as the basis for problem, cause, or solution occurrences in the document. For example, the solution portion of the document may be retained as text for presentation to the agent.

In its simplest form, each document is used to create a chain of a problem node, a cause node, and a solution node. The indicator conditions on the arcs joining the nodes are determined based on the text of the document and the facts identified from the text. These chains of nodes for multiple documents are then combined by the system to make an equivalent inference graph, for example, by combining nodes with the same relevance conditions and predecessor nodes.

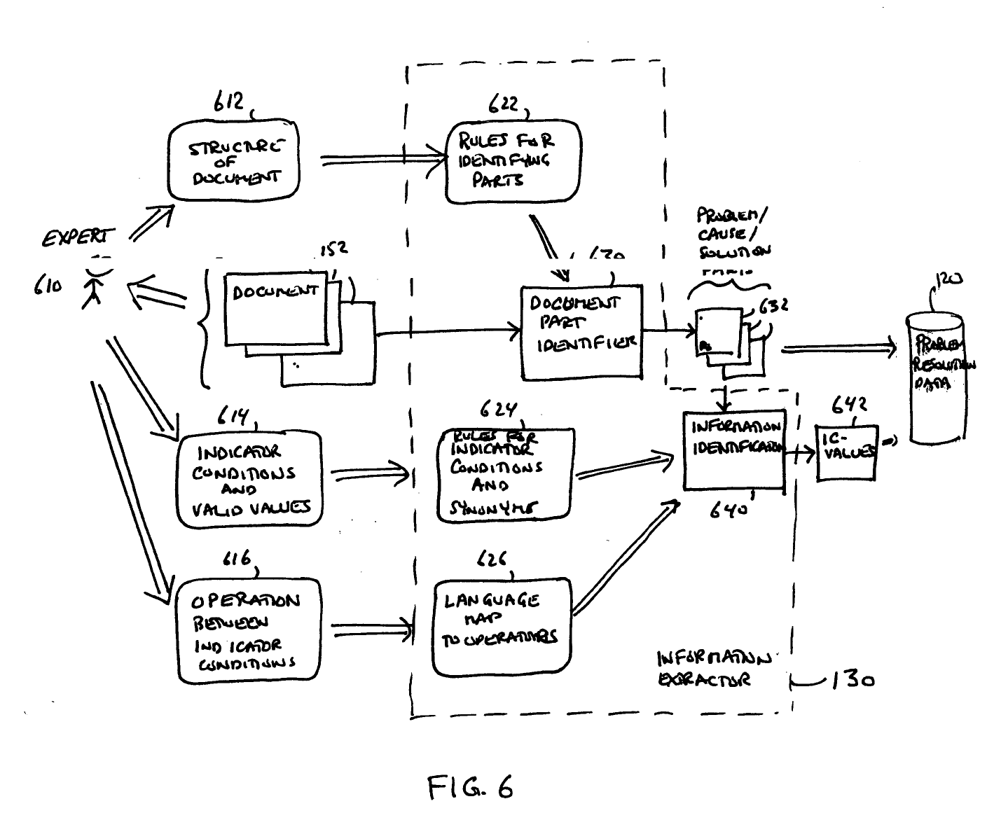

Referring to FIG. 6, various types of information extractors 130 can be used with the system, including extractors that use rule-based techniques. For a rule-based information extractor, configuration of the extractor generally begins with interviewing one or more experts 610 who are familiar with the problem domain and the documents 152 in the particular document source being addressed. In general a particular information extractor 130 is applicable to one of the document sources, although there may be situations in which a document structure is common to multiple domains and a common information extractor can be used. Various types of information are obtained through the interviews of the expert(s), including information about the structure of the documents 612, information about indicator conditions and valid fact values 614, and information about the operations between indicator conditions 616 and their representation in the language of the documents.

Based on the information 612-616, a person, (such as a programmer or knowledge engineer, specifies corresponding rules 622-626, including rules 622 for identifying parts of documents that are associated with the various problem resolution phases, rules 624 for extracting indicator conditions and fact values from the parts of the documents, and rules 626 or other representation of a language map to determine operators between indicator conditions that are found in the portions of the documents. For example, in some documents usage of the word “with” may map to the logical AND operator, as in “ . . . this problem can occur when Oracle 7 is used with Windows NT.” In this example, the indicator conditions might be “database=Oracle 7” and “operating system=Windows NT” and the Boolean expression combines these indicator conditions with a logical AND operation. In another example, “without” may map to a logical AND NOT operator.

The rule-based information extractor 130 includes a module 630 for identifying parts of a document, which is configured by the rules 622 for identifying the parts. For a particular document input to the information extractor, the output of the module 630 is a specification (e.g., start and end lines in the document) of a set of document parts 632, along with their association with particular problem resolution phases (i.e., problem, cause, solution).

An information identification module 640 is configured according to rules 624 and rules 626, and processes the parts 632 of the document that are identified by module 630. The product of this identification module is a set of indicator conditions 642 that are associated with each of the parts and associated Boolean express that combines the indicator conditions.

The document parts 632 and the corresponding indicator conditions 642 are used to construct the inference graph, with each part of a document corresponding to a node (occurrences of a phase) of the inference graph with possibly multiple parts of a document corresponding to a common node, and the indicator conditions and Boolean expression being associated with the arcs that link the nodes.

In addition to use of experts to determine the rules for processing documents, domain experts are interviewed to identify domain information such as sets of indicator conditions for the domain (i.e., both the types of facts and the valid fact values). For example, an expert may provide a set of valid identifiers of operating systems under which a software product can be used. This domain information is also used by the information extractor 130, as well as by the problem resolution system 110 in support of an interaction between an agent and an end user.

Another mode for augmenting the problem resolution data 120 relates to situations in which an agent resolves a user's problem but that problem has not yet been incorporated in the data. For example, even after soliciting facts that were hoped to be suitable for resolving the problem the system does not necessarily provide a solution if the problem was not previously seen. However, the agent may be able to resolve the user's problem, for example, by locating an analogous problem in the data that is not strictly consistent with the facts. Having resolved the problem, the agent submits a new report to the system, which results in a new chain of problem, cause and solution node. This new chain can be combined with the existing data to augment the overall problem resolution data.

In alternative versions of the system, various alternative criteria can be used to order questions that are presented to the agent. For example, rather than presenting the questions that relate to the greatest reduction in possible nodes, questions that are related to most recently entered documents may be preferred. Alternatively, questions that are most likely to resolve the problem in the fewest number of steps can be preferred.

In another alternative, the system includes a proactive notification mode in which end users are notified of potential problems when new documents are processed by the system. The users for whom the document may be relevant are selected based on stored facts (i.e., a profile) for each user.

Other multiple phase approaches than problem, cause, solution can be used. For example, the cause phase may be omitted. Alternatively, problem, hypothesis, and test phases can be used.

The automated portions of the system are implemented in software for execution on a general-purpose computer or a system made up of multiple computers. The software is stored on media such as magnetic disks, or provided to the system over a data network. Various types of programming languages can be used, ranging from low-level languages to languages suited for logic-based applications or expert systems. End users may interact with versions of the system directly, bypassing the need for the agents, for example using a Web-based interface. The software may also be distributed to end users along with other products, for example, to provide an online “help” features.

Many other implementations of the invention other than those described above are within the invention, which is defined by the following claims.

1. A method for computer-assisted problem resolution comprising:
for each of one or more sources of documents related to problem resolution, configuring an automated information extractor to identify problem resolution information from documents from the source,
wherein the information extractor is configured to identify portions of the documents, each portion being associated with a phase of problem resolution, and
wherein the information extractor is configured to determine relevance conditions associated with the identified portions.

2. The method of claim 1 wherein a separate information extractor is configured for each of multiple of the sources of documents.

3. The method of claim 1 wherein the sources of documents all relate to problem resolution in a single domain.

4. The method of claim 1 wherein the relevance condition includes a logical expression based on a set of facts represented in the identified portions.

5. The method of claim 1 wherein configuring the automated information extractor includes configuring a rule-based system.

6. The method of claim 5 wherein configuring the rule-based system includes determining rules for the rule-based system that representing knowledge obtained from people knowledgably in a domain which is associated with the documents.

7. The method of claim 1 further comprising applying the information extractor to documents from one of the sources, including storing data representing at least the determined relevance conditions and the identified portions.

8. The method of claim 7 wherein the stored data includes an inference graph for problem resolution.

9. The method of claim 1 wherein the information extractor is configured to identify information associated with each of a plurality of sequential phases of problem resolution each phase including a plurality of occurrences of the phase, and each identified portion of a document is associate with one of the phases.

10. The method of claim 9 wherein the sequential phases include a problem phase followed by a solution phase.

11. The method of claim 10 wherein the sequential phases further include a cause phase following the problem phase and prior to the solution phase.

12. The method of claim 9 further comprising applying the information extractor to documents from one of the sources and storing data representing the problem resolution information, at least some of the problem resolution information being related to each of the sequential phases.

13. The method of claim 12 further comprising:
for each of the phases in succession,
identifying information that if known would be useful for reducing a number of possible occurrences for that phase,
obtaining at least some of the identified information, and
determining possible occurrences for the phase based at least on the obtained information.

14. The method of claim 13 wherein determining the possible occurrences for the phase is further based on possible occurrences determined in prior of the phases.

15. The method of claim 13 wherein the occurrences of a problem phase are each associated with a problem, and the occurrences of the solution phase are each associated with a solution.

16. The method of claim 13 wherein each occurrence of a phase is associated with one or more indicator conditions that form a logical expression, and identifying the information useful for determining possible occurrences includes identifying indicator conditions whose value if known would contribute to determining the possible occurrences.

17. The method of claim 16 wherein identifying the information further includes ordering the indicator conditions that would contribute to determining the possible occurrences.

18. The method of claim 17 wherein obtaining the information includes prompting for the information according to the ordering.

19. The method of claim 18 wherein prompting includes displaying indications associated with multiple of the identified information according to the ordering.

20. The method of claim 13 further comprising presenting a plurality of completion indicators each associated with a different one of the phases, wherein the competition indicator of each phase presents a measure of remaining possible occurrences for that phase.

21. The method of claim 20 wherein the measure of remaining possible occurrences includes an indicator that the number of remaining possible occurrences is below a threshold.

22. The method of claim 21 wherein the completion indicator for a phase provides an indication that a next phase should be initiated.

23. The method of claim 13 wherein the data related to each of a plurality of sequential phases includes a graph representation including nodes each associated with a different occurrence of the phase, and arcs coupled to the nodes, each arc being associated with an indicator condition for a node to which it is coupled.

24. The method of claim 23 wherein the data for multiple of the phases includes a common graph for the phases, and at least some of the arcs couple occurrences in one phase to occurrences in a following phase.

25. The method of claim 24 wherein the common graph forms an inference network.

26. The method of claim 13 further comprising interactively updating the data related to each of the sequential phases using based a problem resolution not previously represented in the data.

27. Software stored on a computer-readable medium comprising instructions for causing a computer system to:
for each of one or more sources of documents related to problem resolution, configure an automated information extractor to identify problem resolution information from documents from the source,
wherein the information extractor is configured to identify portions of the documents, each portion being associated with a phase of problem resolution, and
wherein the information extractor is configured to determine relevance conditions associated with the identified portions.

28. The software of claim 27 wherein the instructions further causing the computer system to apply the information extractor to documents from one of the sources, and to store data representing at least the determined indicator conditions and the identified portions.

29. The software of claim 27 wherein the instructions further causing the computer system to identify information associated with each of a plurality of sequential phases of problem resolution each phase including a plurality of occurrences of the phase, and each identified portion of a document is associate with one of the phases.

30. The software of claim 27 wherein the instructions further causing the computer system to apply the information extractor to documents from one of the sources and storing data representing the problem resolution information, as least some of the problem resolution information being related with each of the sequential phases.

31. The software of claim 30 wherein the instructions further causing the computer system, for each of the phases in succession, to:
identify information that if known would be useful for reducing a number of possible occurrences for that phase,
obtain at least some of the identified information, and
determine possible occurrences for the phase based at least on the obtained information.

32. A system for computer-aided problem resolution comprising:
a plurality of information extractors, each adapted to automatically identify problem resolution data from documents form a corresponding source of documents;
storage for the problem resolution data; and
a problem resolution system configured to aid in the resolution of a problem using stored problem resolution data.

33. The system of claim 32 wherein the information extractors include a rule-based information extractor.

34. The system of claim 32 wherein the problem resolution data includes an inference graph.

35. The system of claim 32 wherein the problem resolution system is configured to operate in a sequence of sequential phases, each associated with a different phase of problem resolution.

36. A system for computer-aided problem resolution comprising:
means information extractors, including a plurality of individual means for information extraction each adapted to automatically identify problem resolution data from documents form a corresponding source of documents;
means for storing a representation of the problem resolution data; and
means for problem resolution configured to aid in the resolution of a problem using stored problem resolution data.
